(19) United States
(12) Patent Application Publication
(10) Pub. No.: US 2026/0175544 A1
(43) Pub. Date: Jun. 25, 2026

(54) A POLYOLEFIN COMPOSITE AND A METHOD OF PREPARATION THEREOF

(71) Applicant: Agency for Science, Technology and Research, Singapore (SG)

(72) Inventors: Warintorn THITSARTARN, Singapore (SG); Xikui ZHANG, Singapore (SG); Jayven Chee Chuan YEO, Singapore (SG); Ting Ting LIN, Innovis (SG)

(21) Appl. No.: 18/776,539

(22) PCT Filed: Jan. 27, 2023
(86) PCT No.: PCT/SG2023/050050

§ 371 Date: Jul. 18, 2024

(30) Foreign Application Priority Data
Jan. 28, 2022 (SG) 10202200931W

(51) Int. Cl. B32B 27/08; B32B 27/32

(52) U.S. Cl. CPC B32B 27/08; B32B 27/32; C08L 2666/02

(57) ABSTRACT

Described herein is a polyolefin composite and a method of preparation. The method includes blending a mixture comprising 50 to 94.9 weight percent (wt %) of a matrix polymer, 5 to 40 wt % of a reinforcement polymer; and 1 to 20 wt % of a crosslinked molecule and/or 0.1 to 10 wt % of a nanofiller to provide a blended mixture, wherein the weight percent of each component is with respect to the polyolefin composite; and forming the polyolefin composite from the blended mixture, wherein the matrix polymer is a first polyolefin with a number average molecular weight of at most 300,000, and the reinforcement polymer is a second polyolefin with a number average molecular weight of at least 1,500,000. The polyolefin composite includes the matrix polymer, the reinforcement polymer, and the crosslinked molecule and/or the nanofiller as described aforementioned.

### CROSS-REFERENCE TO RELATED APPLICATIONS

This application is filed under 35 U.S.C. 371 as a U.S. National Phase application of International Patent Application serial number PCT/SG2023/050050, filed Jan. 27, 2023, which claims priority to Singapore patent application Ser. No. 10/202,200931W titled “Method to strengthen polymer nanocomposite and its composition” filed on 28 Jan. 2022. All applications are is incorporated by reference herein in their entirety.

### TECHNICAL FIELD

The present inventor relates to polyolefin compositions with improved mechanical properties and methods of preparation thereof.

### BACKGROUND

In general, a polyolefin has relatively poor mechanical properties compared to other polymers. There are many methods to improve the mechanical properties of a polyolefin. One of the methods is by compounding the polyolefin with other polymers. However, the compatibility between the polyolefin and compound polymer is a major issue. Due to the non- or low-polarity of the polyolefin, the interaction between the polymer chain of the polyolefin and another polymer is poor. In addition, compounding with other polymers may affect the crystallinity of the polyolefin which may worsen rather than improve the mechanical properties of the polyolefin.

### SUMMARY

Described herein is a polyolefin composite and a method of preparation. The polyolefin composite contains a matrix polymer, a reinforcement polymer, and a crosslinked molecule and/or a nanofiller. The polyolefin composite may be prepared by blending a mixture comprising a matrix polymer, a reinforcement polymer; and a crosslinked molecule and/or a nanofiller to provide a blended mixture; and forming the polyolefin composite from the blended mixture.

In a first aspect, there is provided a method of preparing a polyolefin composite, the method comprising blending a mixture comprising 50 to 94.9 weight percent (wt %) of a matrix polymer, 5 to 40 wt % of a reinforcement polymer; and 1 to 20 wt % of a crosslinked molecule and/or 0.1 to 10 wt % of a nanofiller to provide a blended mixture, wherein the weight percent of each component is with respect to the polyolefin composite; and forming the polyolefin composite from the blended mixture, wherein the matrix polymer is a first polyolefin with a number average molecular weight of at most 300,000, and the reinforcement polymer is a second polyolefin with a number average molecular weight of at least 1,500,000.

Preferably, the first polyolefin and the second polyolefin are each independently a polymer or a copolymer, wherein a monomer of the polymer or at least one monomer of the copolymer (preferably both monomers) is an olefin selected from the group consisting of ethylene, propylene, 1-pentene, 1-butene, 4-methyl-1-pentene, 1-hexene, 1-octene, 1-decene, styrene, ethylidene norbornene, 1,4-hexadiene, 1,5-hexadiene, 1,7-octadiene, 1,9-decadiene, dicyclopentadiene, and ethylene-propylene-diene monomer.

Preferably, the first polyolefin and second polyolefin have the same monomer or the same at least one monomer of the copolymer.

In an embodiment, the matrix polymer is high density polyethylene, and the reinforcement polymer is ultra-high molecular weight polyethylene.

Preferably, the polyolefin composite comprises 3 to 15 wt % of the crosslinked molecule, preferably 5 to 10 wt % of the crosslinked molecule.

Preferably, the polyolefin composite comprises 0.2 to 5 wt % of the nanofiller, preferably 0.5 to 2.5 wt % of the nanofiller.

Preferably, the number average molecular weight of the matrix polymer is from 10,000 to 300,000.

Preferably, the number average molecular weight of the reinforcement polymer is from 1,500,000 to 7,000,000.

Preferably, the crosslinked molecule is a crosslinked polymer, preferably the crosslinked polymer has a degree of crosslinking of 10% or less.

Preferably, the matrix polymer, the reinforcement polymer and the crosslinked polymer have the same monomer.

Preferably, the method further comprises crosslinking a third polyolefin with a peroxide and/or an organosilane to form the crosslinked polymer.

Preferably, the nanofiller is a rigid filler and selected from the group consisting of rod-liked glass, carbon, polymeric, metal oxides, metallic, and cellulose-based fibrous fillers.

Preferably, the nanofiller has a particle size from 0.01 micrometre (μm) to 100 μm.

Preferably, the method further comprises adding a compatibilizer to the mixture. More preferably, the compatibilizer is a polymer with a grafted polar functional group of an acid anhydride or an ester, preferably the polar functional group is selected from the group consisting of maleic anhydride, hydroxyl, carboxylic, carboxylate derivatives, citraconic anhydride, endo-bi-cyclo [2,2,1}-1,4,5,6,7,7-hexa-chloro-5-heptene-2,3-dicarboxylic acid anhydride, endo-bi cyclo [2,2,1]-5-heptene-2,3-dicarboxylic acid anhydride, cis-4-cyclohexene-1,2-dicarboxylic acid anhydride, methyl acrylate, methyl methacrylate, ethyl acrylate, ethyl methacrylate, butyl acrylate, butyl methacrylate, maleate monoester and maleate diester. In an embodiment, the compatibilizer is 0.1 to 50 percentage by weight of the polyolefin composite.

Preferably, the method further comprises combining a plurality of batches of the blended mixture prior to forming the polyolefin composite.

Preferably, forming the polyolefin composite comprises extruding the blended mixture.

In a second aspect, there is provided a polyolefin composite comprising 50 to 94.9 wt % of a matrix polymer, 5 to 40 wt % of a reinforcement polymer, and 1 to 20 wt % of a crosslinked molecule and/or 0.1 to 10 wt % of a nanofiller, wherein the matrix polymer is a first polyolefin with a number average molecular weight of at most 300,000, the reinforcement polymer is a second polyolefin with a number average molecular weight of at least 1,500,000.

Preferably, the first polyolefin and second polyolefin are each independently a polymer or a copolymer, wherein a monomer of the polymer or at least one monomer of the copolymer (preferably both monomers) is an olefin selected from the group consisting of ethylene, propylene, 1-pentene, 1-butene, 4-methyl-1-pentene, 1-hexene, 1-octene, 1-decene, styrene, ethylidene norbornene, 1,4-hexadiene, 1,5-hexadiene, 1,7-octadiene, 1,9-decadiene, dicyclopentadiene, and ethylene-propylene-diene monomer.

Preferably, the first polyolefin and second polyolefin have the same monomer or the same at least one monomer of the copolymer.

Preferably, the matrix polymer is high density polyethylene, and the reinforcement polymer is ultra-high molecular weight polyethylene.

Preferably, the polyolefin composite comprises 3 to 15 wt %, of the crosslinked molecule, preferably 5 to 10 wt % of the crosslinked molecule.

Preferably, the polyolefin composite comprises 0.2 to 5 wt % of the nanofiller, preferably 0.5 to 2.5 wt % of the nanofiller.

Preferably, the number average molecular weight of the matrix polymer is from 10,000 to 300,000.

Preferably, the number average molecular weight of the reinforcement polymer is from 1,500,000 to 7,000,000.

Preferably, the crosslinked molecule is a crosslinked polymer, preferably the crosslinked polymer has a degree of crosslinking of 10% or less.

Preferably, the matrix polymer, the reinforcement polymer and the crosslinked polymer have the same monomer, preferably the crosslinked polymer is crosslinked with a peroxide (preferably organic peroxide) and/or an organosilane.

Preferably, the nanofiller is a rigid filler and selected from the group consisting of rod-liked glass, carbon, polymeric, metal oxides, metallic, and cellulose-based fibrous fillers.

Preferably, the nanofiller has a particle size from 0.01 μm to 100 μm.

Preferably, the polyolefin composite further comprises a compatibilizer. More preferably, the compatibilizer is a polymer with a grafted polar functional group of an acid anhydride or an ester, preferably the polar functional group is selected from the group consisting of maleic anhydride, hydroxyl, carboxylic, carboxylate derivatives, citraconic anhydride, endo-bi-cyclo [2,2,1}-1,4,5,6,7,7-hexa-chloro-5-heptene-2,3-dicarboxylic acid anhydride, endo-bi cyclo [2,2,1]-5-heptene-2,3-dicarboxylic acid anhydride, cis-4-cyclohexene-1,2-dicarboxylic acid anhydride, methyl acrylate, methyl methacrylate, ethyl acrylate, ethyl methacrylate, butyl acrylate, butyl methacrylate, maleate monoester and maleate diester. In an embodiment, the compatibilizer is 0.1 to 50 wt % of the polyolefin composite.

In a third aspect, there is provided a rope or a sling comprising a polyolefin composite made according to the first aspect or a polyolefin composite according to the second aspect.

Advantageously, the tensile strength of the polyolefin composites increased by up to 40% and the elongation at break reduced by more than 90%. Advantageously, the addition of the nanonfiller increases the crystallinity of the polyolefin composite. Advantageously, the addition of crosslink molecules increased the thermal stability of HDPE and enhances the creep resistance of the polyolefin composite but decreases the crystallinity and may potentially be offset by the addition of the nanofiller.

### DETAILED DESCRIPTION

In the Figures:

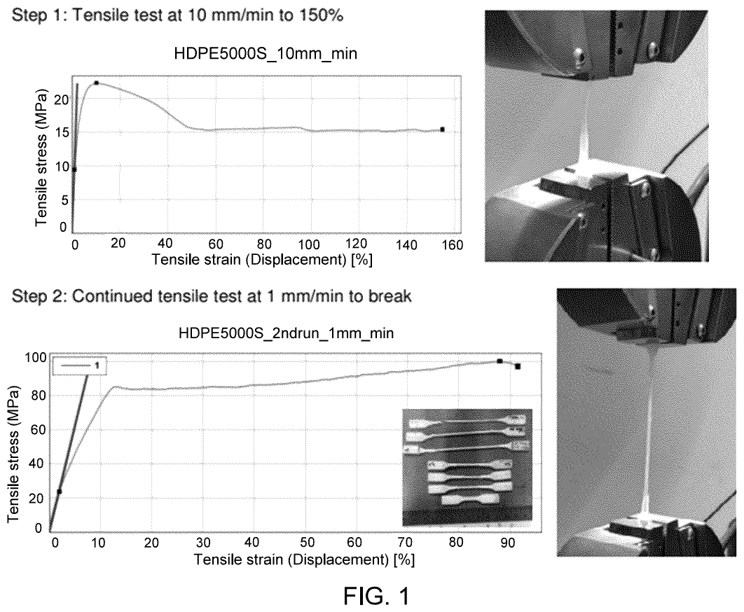

Figure (FIG. 1 shows a two-step tensile test conducted on the polymer composites.

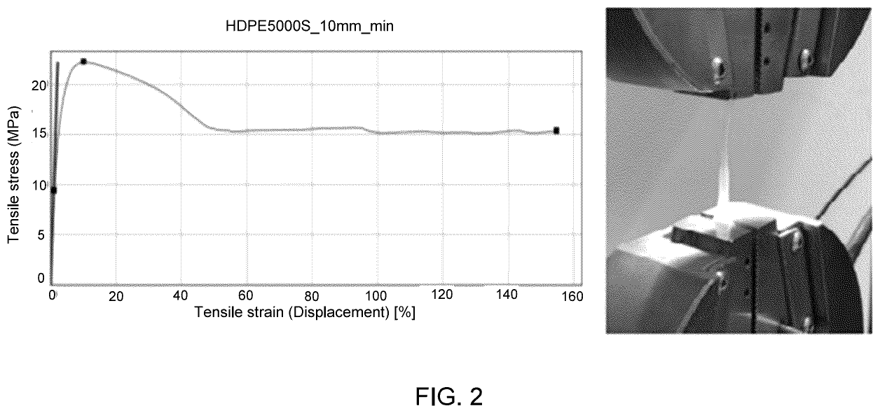

FIG. 2 shows a one-step tensile test conducted on the polymer composites.

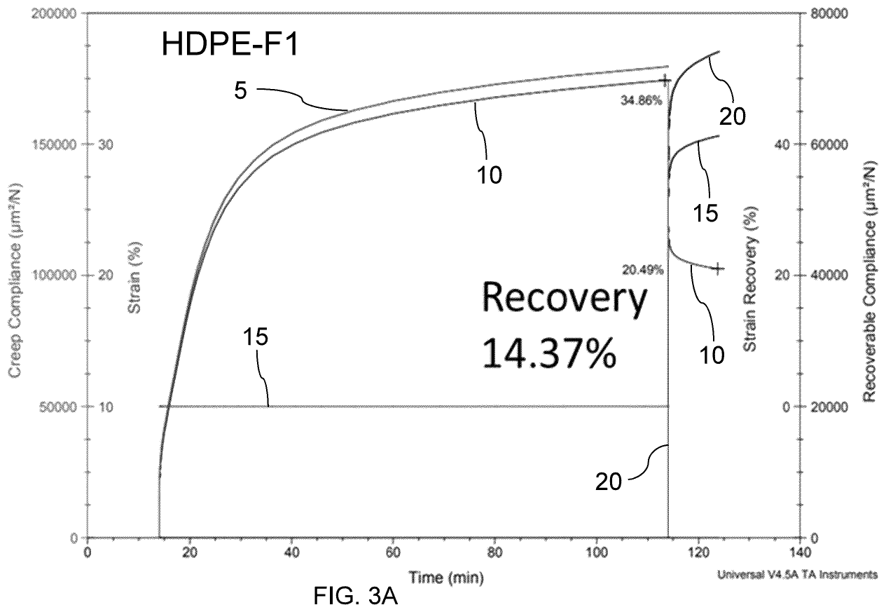

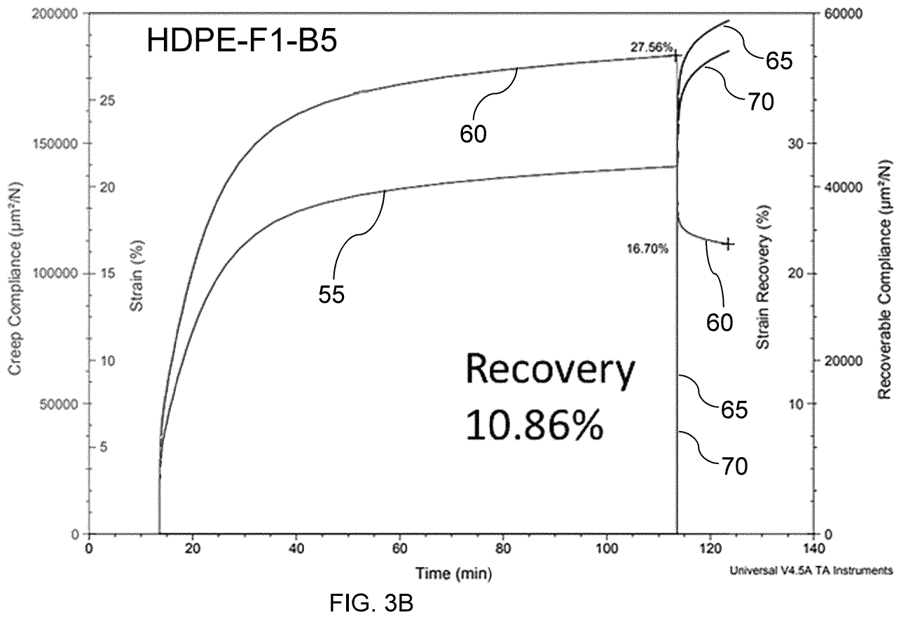

FIG. 3A and FIG. 3B shows a comparison of two samples in the absence (HDPE-F1) and presence (HDPE-F1-B5) of crosslinked molecules respectively.

Unless defined otherwise, all technical and scientific terms used herein have the meaning commonly understood by a person skilled in the art to which this invention belongs.

Although each of these terms has a distinct meaning, the terms “comprising”, “consisting of” and “consisting essentially of” may be interchanged for one another throughout the instant application. The term “having” has the same meaning as “comprising” and may be replaced with either the term “consisting of” or “consisting essentially of”.

The terms “about”, “approximately”, “substantially” must be read with reference to the context of the application as a whole, and have regard to the meaning a particular technical term qualified by such a word usually has in the field concerned. For example, it may be understood that a certain parameter, function, effect, or result can be performed or obtained within a certain tolerance, and the skilled person in the relevant technical field knows how to obtain the tolerance of such term.

The phrase “at least one of A and B” means it requires only A alone, B alone, or A and B, i.e. only one of A or B is required. The phrase “A and/or B” includes A alone, B alone and A and B.

The terms “percent by weight”, “weight percentage (wt %)”, “weight-weight percentage (% w/w)” and the like are used interchangeably herein. Percent by weight refers to the percentage of a material on a mass basis as it is comprised in a composition, mixture or solution.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

Where a range of values is recited, it is to be understood that each intervening integer value, and each fraction thereof, between the recited upper and lower limits of that range is also specifically disclosed, along with each subrange between such values. The upper and lower limits of any range can independently be included in or excluded from the range, and each range where either, neither or both limits are included is also encompassed within the invention. Where a value being discussed has inherent limits, for example where a component can be present at a concentration of from 10 to 50%, those inherent limits are specifically disclosed. Where a value is explicitly recited, it is to be understood that values which are about the same quantity or amount as the recited value are also within the scope of the invention, as are ranges based thereon.

Various embodiments herein describe a method of preparing self-reinforced polyolefin composites by (1) increasing the polymer chain entanglement, (2) adding crosslinked molecules and/or (3) nanofillers to restrict the mobility of polymer chains and increase the crystallinity degree of the polymer. In the various polyolefin composites prepared, the tensile strength of the developed composite increased by up to 40% and the elongation at break reduced by more than 90%, suggesting the strength and dimension stability improvement.

The polyolefin composite samples were tested at the very high crystallization degree; namely, the sample was slowly pulled, allowing the polymer chain to form the perfect alignment. The result shows that compared to pure HDPE, the strength of the developed composite increased by up to 18% and the elongation reduced by more than 40% at the high degree of crystallization stage, suggesting improvement of the strength and dimension stability of the polyolefin composite. Moreover, the crystallization degree was increased. These properties make the polyolefin composite material suitable for applications that required a high level of fiber orientation such as a rope and a sling.

### Methodology:

The self-reinforced polyolefin composite contains a matrix polymer (polyolefin), a reinforcement polymer (or very long chain polymer), and is modified with a nanofiller and/or crosslinked molecules. An example of a matrix polymer may be high density polyethylene (HDPE) and an example of a reinforcement polymer is ultra-high molecular weight polyethylene (UHWWPE). In an example, two polyethylenes (PEs) with different molecular weights (MW) were used to create the inter-molecular entanglement to improve the pulling strength and limit the polymer chain mobility. In some embodiments, crosslinked polyethylene (PE) molecules were added to increase the matrix rigidity. In some embodiments, a nanofiller (for example, calcium carbonate) was added with the purpose of increasing the crystallinity.

The composition in each part was mixed using a high-speed mixer. The mixing process was carried out for a period of between 1 and 10 minutes and at a high mixing speed of between 50 and 1000 rpm. After mixing, the mixture was compounded by a twin-screw extruder. A twin-screw extruder is used to effectively provide the high shear rate and distribution required for uniform blending of the mixture. The twin-screw L/D ratio, screw configurations, extrusion time, extrusion speed, extrusion temperature and other extrusion conditions can be suitably selected depending on the particular purpose. The blending process may be performed in the range of 180 to 250° C. The L/D ratio of screw may be from 16 to 40. The rotor speed may be set between 50 and 400 rpm. The range of UHMWPE, crosslinked molecules and nanofiller components in weight percentage may be from 5-40 wt %, 1-20 wt %, and 0.1-10 wt % respectively. After that, the extruded polyolefin composition was injected for tensile testing.

An example of a compounding process that may be used may be the following sequential process:
Step 1—the very long chain polymer (i.e., UHMWPE), which typically has difficulty melting, was added into the mixer first, followed by the matrix polymer (HDPE);
Step 2—The nanofillers and/or crosslinked molecules were added as required in the polyolefin composite.

An example of the crosslinked molecules is crosslinked HDPE. Crosslinked HDPE may be formed via a chemical reaction of HDPE with (organic) peroxide and/or organosilane compound and may be formed prior to Steps 1 and 2 above. An example of the crosslinked molecules is crosslinked HDPE initiated by peroxide. In an embodiment, the degree of crosslinking is 10% or less, preferably 5% or less. The degree of crosslinking may be determined by Soxhlet extraction tests. In an example of a Soxhlet extraction test procedure approximately 0.3 g of each sample, wrapped in a No. 1 Whatman® filler paper, was extracted for 24 hours in refluxing xylene. After extraction, the samples were dried in a vacuum oven until constant weight. The gel ratio was determined by measuring the weight of dried gel with respect to the initial sample weight.

Polyolefin composites with different compositions were prepared according to the above procedure. Table 1 below shows the composition of the samples prepared with the percentages by weight (wt % or wt. %) of the various components in each sample. The matrix polymer is high density polyethylene (HDPE) with a number average molecular weight of at most 300,000. HDPE available as Innoplus HD5000S from PTT Global Chemical is used in the samples herein with a density of 0.954 g/cm3 (ASTM D1505) and melting point of 125° C. in the product description sheet. The reinforcement polymer is ultra-high molecular weight polyethylene (UHMWPE) with a number average molecular weight of at least 1,500,000. UHMWPE available as POLIMAXX® UHMWPE U211B with an average molecular about 1.7 million g/mol is used as the reinforcement polymer in the samples herein. The nanofiller is calcium carbonate, and the crosslinked molecule is crosslinked polyethylene (Innoplus HD5000S from PTT Global Chemical) with a gel degree of at most 4%.

TABLE 1
Composition of samples

| | | | | Nano- | Crosslinked |
|---|---|---|---|---|---|
| Sample Name | HDPE | | UHMWPE | filler | molecule |
| HDPE F1 | 90 | wt % | 10 wt % | | |
| HDPE F1-A0.5 | 89.5 | wt % | 10 wt % | 0.5 wt % | |
| HDPE F1-A2.5 | 87.5 | wt % | 10 wt % | 2.5 wt % | |
| HDPE F1-B5 | 85 | wt % | 10 wt % | | 5 wt % |
| HDPE F1-B10 | 80 | wt % | 10 wt % | | 10 wt % |
| HDPE F1- | 84.5 | wt % | 10 wt % | 0.5 wt % | 5 wt % |
| B5-A0.5 | | | | | |
| HDPE F1- | 79.5 | wt % | 10 wt % | 0.5 wt % | 10 wt % |
| B10-A0.5 | | | | | |
| HDPE F2 | 80 | wt % | 20 wt % | | |
| HDPE F2-A0.5 | 79.5 | wt % | 20 wt % | 0.5 wt % | |
| HDPE F2-A2.5 | 77.5 | wt % | 20 wt % | 2.5 wt % | |
| HDPE F2-B5 | 75 | wt % | 20 wt % | | 5 wt % |
| HDPE F2-B10 | 70 | wt % | 20 wt % | | 10 wt % |
| HDPE F2- | 74.5 | wt % | 20 wt % | 0.5 wt % | 5 wt % |
| B5-A0.5 | | | | | |
| HDPE F2- | 69.5 | wt % | 20 wt % | 0.5 wt % | 10 wt % |
| B10-A0.5 | | | | | |
| HDPE F3 | 70 | wt % | 30 wt % | | |
| HDPE F3-A2.5 | 67.5 | wt % | 30 wt % | 2.5 wt % | |

### Sample Preparation:

To evaluate the performance of the resin, the samples were then injection molded into various specimens for mechanical testing using a piston injection molding system (Haake MiniJet, Thermo Fisher Scientific). The polymers were melted at the injection temperature of 230° C., a mold temperature of 60° C., an injection pressure of 900 bar for 15 s, and a holding pressure of 450 bar for 10 s.

### Characterization:

Tensile Testing: The injection molded sample used for the tensile test has the dimensions of 63.5×3.14×3.2 mm³. The test was carried out using the Instron 5569 Table Universal testing machine in a two-steps process as shown in FIG. 1. The sample is first cold-draw at a tensile speed of 10 mm/min to 150% tensile strain followed by tensile testing at a tensile speed of 1 mm/min.

### Differential Scanning Calorimeter (DSC):

Melting and crystallization of the self-reinforced polyolefin composite were characterized using DSC (TA Instruments Q100). About 5-10 mg of each sample was filled in an aluminum hermetic pan under the following protocol: The sample was first heated from 25 to 200° C. to erase any thermal history, held isothermally for 2 min, and cooled to 25° C., and a second heating which proceeded to 200° C. The rate for both the heating and cooling scans was 20° C./min under a constant flow of nitrogen at 50 mL/min. The thermal properties such as melting temperature (Tₘ), crystallization temperature (T_{c}), crystallization enthalpy (ΔH_{c}) heat enthalpy were the second (ΔHₘ) obtained from heating curve. The results of the various samples are shown in Table 2. HDPE 5000S is a commercially available HDPE and serves as a basis for comparison of the polyolefin composites prepared.

Part 1: Samples were Pulled Two Times to Simulate the High Crystallinity Degree

The results in Table 2 show the HDPE/UHMWPE compositions with 10 wt % (F1), 20 wt % (F2), and 30 wt % (F3) of UHMWPE with HDPE making up the rest. Two approaches were used to further improve the performance of the HDPE/UHMWPE blend with an additive (the weight percent of the HDPE is decreased accordingly for the additive):
Additive A: adding calcium carbonate as nanofiller (0.5 and 2.5 wt %)
Additive B: adding crosslinked HDPE as crosslink molecules (5 and 10 wt %)

It was found that the addition of UHMWPE into HDPE increased the crystallinity of HDPE. The addition of the nanofiller into HDPE at low content (0.5 wt %) increased the crystallinity of HDPE, but decreased the crystallinity of HDPE at higher content (2.5 wt %). The addition of crosslink molecules increased the thermal stability of HDPE, but decreased its crystallinity.

Table 3 shows the tensile strength and elongation at break of the developed composite. Introduction of UHMWPE can enhance the tensile strength of HDPE (˜15%) (see HDPE F1), and the tensile strength of the blend can slightly further increase (up to 16%) with the nanofiller addition (see HDPE F2-A2.5). All samples containing HDPE and UHMWPE with and without a nanofiller have maximum tensile strength of greater than 102 MPa, much higher than neat HDPE tensile strength (97 MPa).

Adding the crosslinking molecule does not further increase the strength of the HDPE/UHMWPE and could possibly be due to the chain scission effect during the crosslinking reaction. This results in the reduction of molecular weight and less entanglement between polymer chains.

For the F1 formula compositions, the effect of self-reinforcement and chain entanglement is not obvious due possibly to the low content (10 wt %) of UHMWPE. The effect of self-reinforcement via polymer entanglement is more obvious when the UHMWPE content increases (F2 formula compositions with 20 wt % of UHMWPE).

For the F2 formula compositions, the elongation at break increases even with the addition of the rigid nanoparticles, in contrast to the F1 formula samples where the elongation at break decreases with the addition of the nanofillers. When the matrix material (polymer) is stretched, the matrix around the nanoparticles is strained by the interface stress, forming a stretched chain crystal network structure, leading to the brittle-ductile transition of the material, which leads to an increase in elongation at break. Another possibility of mechanical property improvement is the change of crystallinity as presented in Table 2.

TABLE 2
Thermal property of self-reinforced polyolefin composites.

| | | ΔHm (enthalphy | | ΔHc (enthalphy |
|---|---|---|---|---|
| | | change of | | change of |
| | | melting), | | crystallization), |
| Formula | Tm, ° C. | J/g | Tc, ° C. | J/g |
| HDPE 5000S | 132.80 | 154.4 | 113.30 | 171.4 |
| HDPE F1 | 132.03 | 162.2 | 114.37 | 168.7 |
| HDPE F1-A0.5 | 132.01 | 162.5 | 114.53 | 170.2 |
| HDPE F1-A2.5 | 134.37 | 146.6 | 112.40 | 149.2 |
| HDPE F1-B5 | 134.12 | 152.0 | 112.65 | 154.5 |
| HDPE F1-B10 | 134.64 | 147.3 | 110.87 | 149.6 |
| HDPE F2 | 134.35 | 166.4 | 112.88 | 169.9 |
| HDPE F2-A0.5 | 133.18 | 161.9 | 114.19 | 168.1 |
| HDPE F2-A2.5 | 133.62 | 153.6 | 112.49 | 157.8 |
| HDPE F2-B5 | 137.61 | 155.5 | 108.39 | 153.6 |
| HDPE F2-B10 | 135.02 | 163.4 | 111.68 | 164.6 |
| HDPE F3 | 138.81 | 153.4 | 109.00 | 159.2 |

TABLE 3
Tensile property of formulated resin after
the 2^{nd} round of stretching (150% stretch)

| | Tensile | Elongation |
|---|---|---|
| Formula | strength, MPa | at break, % |
| HDPE 5000S | 97.12 ± 0.20 | 100.67 ± 11.98 |
| HDPE F1 | 112.09 ± 5.38 | 117.36 ± 13.26 |
| HDPE F1-A0.5 | 109.67 ± 9.32 | 103.41 ± 21.67 |
| HDPE F1-A2.5 | 104.52 ± 10.87 | 87.02 ± 25.72 |
| HDPE F1-B5 | 104.25 ± 4.62 | 95.55 ± 4.52 |

| | |
|---|---|
| HDPE F1-B10 | Break before 150% |

| | | |
|---|---|---|
| HDPE F1-B5-A0.5 | 109.96 ± 6.70 | 80.95 ± 33.51 |

| | |
|---|---|
| HDPE F1-B10-A0.5 | Break before 150% |

| | | |
|---|---|---|
| HDPE F2 | 106.05 ± 8.20 | 62.01 ± 19.23 |
| HDPE F2-A0.5 | 109.98 ± 11.04 | 72.77 ± 24.65 |
| HDPE F2-A2.5 | 112.87 ± 4.48 | 80.16 ± 4.84 |
| HDPE F2-B5 | 102.00 ± 5.59 | 47.87 ± 18.70 |

| | |
|---|---|
| HDPE F2-B10 | Break before 150% |
| HDPE F2-B5-A0.5 | Break before 150% |
| HDPE F2-B10-A0.5 | Break before 150% |
| HDPE F3 | Break before 150% |

Part 2: Samples were Slowly Pulled to Simulate the High Crystallinity Degree

Samples were slowly pulled at 10 mm/min until the sample break as shown in FIG. 2. This experimental procedure was designed purposely to measure the strength of the polyolefin composite with high UHMWPE content (F3, 30 wt % of UHMWPE), which could not be measured by the method in Part 1. PET is polyethylene terephthalate and a commercially available product from Ovation Polymers was used in the tests (Nemcon™ E 30131).

TABLE 4
Tensile strength and elongation at break of the developed composites,
compared against references and engineering benchmark (PET)

| | Tensile | Elongation |
|---|---|---|
| | strength, MPa | at break, % |
| PET (from | 50 | 2.6 |
| specification sheet) | | |
| HDPE 5000S (from | 28.4 | >1000 |
| specification sheet) | | |
| UHMWPE (from | 22 | >300 |
| specification sheet) | | |
| HDPE F3 | 34.50-37.07 | 68.64-57.04 |
| HDPE F3-A2.5 | 36.67-41.69 | 50.58-23.89 |

Table 4 shows the tensile strength and elongation at break of the developed polyolefin composites. Compared with the HDPE and UHMWPE base resin, the F3 series samples shows much higher strength (an increase in about 30%) and lower elongation at break (a decrease of about 90%) Compared to the benchmark polyester (polyethylene terephthalate fiber grade) and UHMWPE, the fiber strength of the developed polyolefin composites is relatively comparable and the percentage elongation at break significantly reduces. This could possibly be due to the dimension stability and that creep resistant is high.

Table 5 shows the tensile properties of the various formulated resin as measured at a crosshead speed of 10 mm/min till 150% elongation. The specimen was prepared according to ASTM D638 standard. The tensile strength is much lower than that of the stretched sample as shown in Table 3, which indicates the stretched process made significant effects on the mechanical properties of the sample. Meanwhile, the elongation of the sample decreases after introducing crosslinked molecules (particularly samples with 10 wt % of the crosslinked molecules). This shows the entanglement of the sample decreases after introducing crosslinked molecules corresponding to the enhancement of creep resistance in the sample.

TABLE 5
Tensile property of the formulated resin (ASTM D638)

| | Tensile | Tensile | |
|---|---|---|---|
| | Modulus, | strength, | Elongation at |
| Formulated resin | MPa | MPa | break, % |
| HDPE5000S | 989.56 ± 45.20 | 22.12 ± 0.20 | 150 |
| HDPE F1 | 1236.88 ± 14.60 | 24.32 ± 0.30 | 154.41 ± 0.64 |
| HDPE F1-A0.5 | 1265.12 ± 52.16 | 24.40 ± 0.42 | 154.44 ± 0.69 |
| HDPE F1-A2.5 | 1351.97 ± 21.74 | 24.47 ± 0.21 | 156.70 ± 2.68 |
| HDPE F1-B5 | 1262.08 ± 10.45 | 24.57 ± 0.23 | 154.36 ± 0.33 |
| HDPE F1-B10 | 1279.86 ± 18.10 | 25.30 ± 0.46 | 131.13 ± 7.56 |
| HDPE F1- | 1353.83 ± 79.00 | 25.04 ± 0.27 | 152.36 ± 1.17 |
| B5-A0.5 | | | |
| HDPE F1- | 1416.97 ± 132.69 | 27.48 ± 3.32 | 106.26 ± 56.91 |
| B10-A0.5 | | | |
| HDPE F2 | 1406.32 ± 22.84 | 26.38 ± 0.28 | 154.19 ± 0.57 |
| HDPE F2-A0.5 | 1418.13 ± 30.37 | 26.64 ± 0.30 | 155.75 ± 7.15 |
| HDPE F2-A2.5 | 1354.76 ± 54.05 | 26.96 ± 0.84 | 152.01 ± 3.41 |
| HDPE F2-B5 | 1315.41 ± 48.06 | 26.70 ± 0.79 | 156.36 ± 2.13 |
| HDPE F2-B10 | 1313.12 ± 36.86 | 27.06 ± 0.51 | 109.05 ± 35.91 |
| HDPE F2- | 1330.97 ± 100.92 | 26.60 ± 0.65 | 119.14 ± 31.28 |
| B5-A0.5 | | | |
| HDPE F2- | 1526.68 ± 96.24 | 31.14 ± 3.02 | 60.01 ± 14.05 |
| B10-A0.5 | | | |
| HDPE F3 | 1273.53 | 35.58 | 68.46 |

The creep and recovery behavior of two samples (HDPE F1 and HDPE F1-B5) were investigated using a Dynamic Mechanical Analyzer (DMA Q800) in tensile mode to determine the effect of the crosslinked molecules on the polyolefin composite. The DMA was heated to 120° C. and equilibrated for 5 minutes. A constant stress of 2 MPa was subsequently placed on the sample for 100 minutes, released the stress and test the sample's recovery.

The results are shown in FIG. 3A and FIG. 3B. In FIG. 3A and FIG. 3B, the curves for the creep resistance are marked by the reference numbers 5 and 55 respectively. The curves for the strain are marked by the reference numbers 10 and 60 respectively. The curves for the strain recovery are marked by the reference numbers 15 and 65 respectively. The curves for the recoverable compliance are marked by the reference numbers 20 and 70 respectively.

From FIG. 3A and FIG. 3B, it may be observed that the addition of crosslinked molecules reduces the strain of sample during constant stress (curves 10 and 60) and result in lower recovery (14% for HDPE F1 and 11% for HDPE F1-B5). This indicates the enhanced creep resistance after the addition of the crosslinked molecules.

Advantageously, the addition of the crosslinked molecules alone maintains the creep resistance of the polyolefin composite during stretching, while the nanofiller may be added for further improvement of the crystallization degree of the polymer composite.

Whilst there has been described in the foregoing description preferred embodiments of the invention, it will be understood by those skilled in the field concerned that many variations or modifications in details of design or construction may be made without departing from the present invention.

1.-34. (canceled)

35. A method of preparing a polyolefin composite, the method comprising:
blending a mixture consisting essentially of 50 to 94.9 weight percent (wt %) of high density polyethylene, 5 to 40 wt % of ultra-high molecular weight polyethylene; and 1 to 20 wt % of crosslinked polyethylene having a degree of crosslinking of 10% or less to provide a blended mixture, wherein the weight percent of each component is with respect to the polyolefin composite; and
forming the polyolefin composite from the blended mixture,
wherein the high density polyethylene has a number average molecular weight of at most 300,000, and the ultra-high molecular weight polyethylene has a number average molecular weight of at least 1,500,000.

36. The method according to claim 35, wherein the polyolefin composite comprises 3 to 15 wt % of the crosslinked polyethylene, preferably 5 to 10 wt % of the crosslinked polyethylene.

37. The method according to claim 35, wherein the polyolefin composite comprises 0.1 to 10 wt % of a nanofiller, preferably 0.2 to 5 wt % of the nanofiller, more preferably 0.5 to 2.5 wt % of the nanofiller.

38. The method according to claim 35, wherein the number average molecular weight of the high density polyethylene is from 10,000 to 300,000.

39. The method according to claim 35, wherein the number average molecular weight of the ultra-high molecular weight polyethylene is from 1,500,000 to 7,000,000.

40. The method according to claim 35, comprising crosslinking polyethylene with a peroxide and/or an organosilane to form the crosslinked polyethylene.

41. The method according to claim 37, wherein the nanofiller is a rigid filler and selected from the group consisting of rod-liked glass, carbon, polymeric, metal oxides, metallic, and cellulose-based fibrous fillers, wherein the nanofiller has a particle size from 0.01 micrometre (μm) to 100 μm.

42. The method according to claim 35, comprising adding a compatibilizer to the mixture, wherein the compatibilizer is a polymer with a grafted polar functional group of an acid anhydride or an ester, preferably the polar functional group is selected from the group consisting of maleic anhydride, hydroxyl, carboxylic, carboxylate derivatives, citraconic anhydride, endo-bi-cyclo [2,2,1}-1,4,5,6,7,7-hexa-chloro-5-heptene-2,3-dicarboxylic acid anhydride, endo-bi cyclo [2,2,1]-5-heptene-2,3-dicarboxylic acid anhydride, cis-4-cyclohexene-1,2-dicarboxylic acid anhydride, methyl acrylate, methyl methacrylate, ethyl acrylate, ethyl methacrylate, butyl acrylate, butyl methacrylate, maleate monoester and maleate diester,
wherein the compatibilizer is 0.1 to 50 percentage by weight of the polyolefin composite.

43. The method according to claim 35, comprising combining a plurality of batches of the blended mixture prior to forming the polyolefin composite.

44. A polyolefin composite consisting essentially of 50 to 94.9 wt % of high density polyethylene, 5 to 40 wt % of ultra-high molecular weight polyethylene, and 1 to 20 wt % of crosslinked ethylene having a degree of crosslinking of 10% or less, wherein the high density polyethylene has a number average molecular weight of at most 300,000, the ultra-high molecular weight polyethylene has a number average molecular weight of at least 1,500,000.

45. The polyolefin composite according to claim 44, wherein the polyolefin composite comprises 3 to 15 wt %, of the crosslinked polyethylene, preferably 5 to 10 wt % of the crosslinked polyethylene.

46. The polyolefin composite according to claim 44, wherein the polyolefin composite comprises 0.1 to 10 wt % of a nanofiller, preferably 0.2 to 5 wt % of the nanofiller, more preferably 0.5 to 2.5 wt % of the nanofiller.

47. The polyolefin composite according to claim 44, wherein the number average molecular weight of the high density polyethylene is from 10,000 to 300,000.

48. The polyolefin composite according to claim 44, wherein the number average molecular weight of the ultra-high molecular weight polyethylene is from 1,500,000 to 7,000,000.

49. The polyolefin composite according to claim 44, wherein the crosslinked polyethylene is crosslinked with a peroxide (preferably organic peroxide) and/or an organosilane.

50. The polyolefin composite according to claim 46, wherein the nanofiller is a rigid filler and selected from the group consisting of rod-liked glass, carbon, polymeric, metal oxides, metallic, and cellulose-based fibrous fillers, wherein the nanofiller has a particle size from 0.01 μm to 100 μm.

51. The polyolefin composite according to claim 44 comprising a compatibilizer, wherein the compatibilizer is a polymer with a grafted polar functional group of an acid anhydride or an ester, preferably the polar functional group is selected from the group consisting of maleic anhydride, hydroxyl, carboxylic, carboxylate derivatives, citraconic anhydride, endo-bi-cyclo [2,2,1}-1,4,5,6,7,7-hexa-chloro-5-heptene-2,3-dicarboxylic acid anhydride, endo-bi cyclo [2,2,1]-5-heptene-2,3-dicarboxylic acid anhydride, cis-4-cyclohexene-1,2-dicarboxylic acid anhydride, methyl acrylate, methyl methacrylate, ethyl acrylate, ethyl methacrylate, butyl acrylate, butyl methacrylate, maleate monoester and maleate diester, wherein the compatibilizer is 0.1 to 50 wt % of the polyolefin composite.

52. A rope or a sling comprising a polyolefin composite made according to claim 35.

53. A rope or a sling comprising a polyolefin composite according to claim 44.
